(19) United States
(12) Patent Application Publication
(10) Pub. No.: US 2012/0147514 A1
(43) Pub. Date: Jun. 14, 2012

(54) CERAMIC PASTE COMPOSITION FOR MULTILAYER CERAMIC CAPACITOR, MULTILAYER CERAMIC CAPACITOR COMPRISING THE SAME, AND METHODS OF MANUFACTURING THE SAME

(75) Inventors: Ju Myung Suh, Anyang (KR); Jun Hee Kim, Hwaseong (KR); Jang Ho Lee, Suwon (KR)

(73) Assignee: SAMSUNG ELECTRO-MECHANICS CO., LTD.

(21) Appl. No.: 13/116,526

(22) Filed: May 26, 2011

(30) Foreign Application Priority Data
Dec. 10, 2010 (KR) 10-2010-0126243

(51) Int. Cl. H01G 4/30; B32B 37/06; B32B 37/14; C04B 35/00; B32B 37/02

(52) U.S. Cl. 361/301.4; 501/1; 156/89.12

(57) ABSTRACT

There are provided a ceramic paste composition for a multilayer ceramic capacitor (MLCC), a multilayer ceramic capacitor comprising the same, and methods of manufacturing the same. The ceramic paste composition for the MLCC includes: a ceramic powder, a first phosphate ester-based dispersant and a second dispersant salt-bonded by a fatty acid and an alkyl amine; a binder including polyvinyl butyral and ethyl cellulose; and a solvent. The ceramic paste composition ceramic powder has a small average particle-diameter and the ceramic powder in the paste has excellent dispersibility.

### CROSS-REFERENCE TO RELATED APPLICATIONS

This application claims the priority of Korean Patent Application No. 10-2010-0126243 filed on Dec. 10, 2010, in the Korean Intellectual Property Office, the disclosure of which is incorporated herein by reference.

### BACKGROUND OF THE INVENTION

1. Field of the Invention

The present invention relates to a ceramic paste composition for a multilayer ceramic capacitor, a multilayer ceramic capacitor comprising the same, and methods of manufacturing the same, and more particularly, to a ceramic paste composition for a multilayer ceramic capacitor having excellent dispersibility, a multilayer ceramic capacitor comprising the same, and methods of manufacturing the same.

2. Description of the Related Art

In general, electronic components such as a capacitor, an inductor, a piezoelectric element, a varistor, a thermistor, or the like, using a ceramic material, include a ceramic element made of the ceramic material, inner electrodes formed within the element, and outer electrodes installed on the surface of the ceramic element and connected to the inner electrodes.

A multilayer ceramic capacitor among the ceramic electronic components includes a plurality of dielectric layers which are laminated, inner electrodes facing each other with one dielectric layer interposed therebetween, and outer electrodes electrically connected to respective facing inner electrodes.

The multilayer ceramic capacitor is widely used as a component for a mobile communications device such as a computer, a PDA, a cellular phone, or the like, due to advantages in that the multilayer ceramic capacitor is miniaturized, has a high capacity, and is easy to mount.

Recently, with the trend towards high-performance, thin-layers and miniaturization in the electric and electronic apparatus industries, electronic components having characteristics such as a compactness, high performance, and a low cost are in great demand. In particular, as high-speed CPUs and miniaturized, light-weight, digitalized, and highly-functional devices have been more widely used, R&D into a multilayer ceramic capacitor (hereinafter, referred to as an ‘MLCC’) having characteristics such as a compactness, thin layers, high capacity, low impedance in a high frequency region or the like has been actively undertaken in response to the demand therefor.

A dielectric layer and an inner electrode used in a highly-layered and high-capacity multilayer ceramic condenser are thin-film sheets. As the thin-film dielectric layer and the thin-film inner electrode are highly-layered, deformation errors may be increased during the stacking and compressing thereof, and as a result, an ultra thin-film and ultra high-capacity MLCC is difficult to implement.

In recent years, a thermal transfer lamination method of transferring a thin-film sheet at a relatively high temperature and high pressure has been used in order to increase the lamination efficiency of the thin-film sheet, and as the amount of laminated thin-film electrodes increases, an error rate in a green chip also increases.

### SUMMARY OF THE INVENTION

An aspect of the present invention provides a ceramic paste composition for a multilayer ceramic capacitor having excellent dispersibility, a multilayer ceramic capacitor (MLCC) comprising the same, and methods of manufacturing the same.

According to an aspect of the present invention, there is provided a ceramic paste composition for an MLCC comprising: a ceramic powder; a first phosphate ester-based dispersant and a second dispersant salt-bonded by a fatty acid and an alkyl amine; a binder including polyvinyl butyral and ethyl cellulose; and a solvent.

The ceramic paste composition for the MLCC may further include a preliminary solvent having a lower viscosity than the solvent.

The ceramic powder may have an average particle-diameter of 100 nm or less.

The solvent may be a terpineol-based solvent.

The preliminary solvent may be one or more selected from a group composed of toluene, ethanol, and a mixture thereof.

The content of the first dispersant may be 10 to 30 parts by weight with respect to the ceramic powder of 100 parts by weight.

The content of the second dispersant may be 10 to 30 parts by weight with respect to the ceramic powder of 100 parts by weight.

The content of the binder may be 10 to 30 parts by weight with respect to the ceramic powder of 100 parts by weight.

The viscosity of the ceramic paste may be 5000 to 20000 cps.

According to another aspect of the present invention, there is provided a method of manufacturing a ceramic paste for an MLCC comprising: forming a initial mixture in a slurry state comprising a ceramic powder, a preliminary solvent, and a first phosphate ester-based dispersant; and forming a secondary mixture in a paste state by mixing a second dispersant salt-bonded by a fatty acid and an alkyl amine, a binder including polyvinyl butyral and ethyl cellulose, and a solvent having a higher boiling point and a higher viscosity than the preliminary solvent with the initial mixture.

The method of manufacturing the ceramic paste for the

MLCC may further include removing the preliminary solvent before forming the secondary mixture.

The preliminary solvent may be one or more selected from a group composed of toluene, ethanol, and a mixture thereof.

The solvent may be a terpineol-based solvent.

The ceramic powder may have an average particle-diameter of 100 nm or less.

The viscosity of the initial mixture in the slurry state may be 10 to 300 cps.

The viscosity of the secondary mixture in the paste state may be 5000 to 20000 cps.

According to another aspect of the present invention, there is provided a multilayer ceramic capacitor (MLCC) comprising: a ceramic element in which a plurality of dielectric layers are stacked; a plurality of inner electrodes formed in one dielectric layer; a dielectric layer margin portion formed at the margin portion of the dielectric layer in which the inner electrode is not formed, and formed of a ceramic paste composition comprising a ceramic powder, a first phosphate ester-based dispersant, a second dispersant salt-bonded by a fatty acid and an alkyl amine, a binder including polyvinyl butyral and ethyl cellulose, and a solvent; and an outer electrode formed on the outer surface of the ceramic element.

The ceramic paste composition may further include a preliminary solvent having a lower viscosity than the solvent.

The ceramic powder included in the ceramic paste composition may have an average particle-diameter of 100 nm or less.

According to another aspect of the present invention, there is provided a method of fabricating an MLCC, comprising: preparing a plurality of ceramic green sheets; forming an inner electrode pattern on the ceramic green sheet; forming a dielectric layer margin portion at the margin portion of the dielectric layer in which the inner electrode pattern is not formed, by using a ceramic paste comprising a ceramic powder, a first phosphate ester-based dispersant, a second dispersant salt-bonded by a fatty acid and an alkyl amine, a binder including polyvinyl butyral and ethyl cellulose, and a solvent; forming a ceramic multilayer body by stacking the ceramic green sheets; forming a ceramic element by firing the ceramic multilayer body; and forming an outer electrode on the outer surface of the ceramic element.

The ceramic paste may be formed by comprising: forming a initial mixture in a slurry state comprising a ceramic powder, a preliminary solvent, and a first phosphate ester-based dispersant; and forming a secondary mixture in a paste state by mixing a second dispersant salt-bonded by a fatty acid and an alkyl amine, a binder including polyvinyl butyral and ethyl cellulose, and a solvent having a higher boiling point and a higher viscosity than the preliminary solvent with the initial mixture.

The method may further include removing the preliminary solvent before forming the secondary mixture.

The preliminary solvent may be one or more selected from a group composed of toluene, ethanol, and a mixture thereof.

The solvent may be a terpineol-based solvent.

The ceramic powder may have an average particle-diameter of 100 nm or less.

The viscosity of the initial mixture in the slurry state may be 10 to 300 cps.

The viscosity of the secondary mixture in the paste state may be 5000 to 20000 cps.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating a MLCC according to an exemplary embodiment of the present invention;

FIG. 2 is a schematic cross-sectional view illustrating a MLCC taken along line A-A′ of FIG. 1;

FIG. 3 is a schematic cross-sectional view illustrating a MLCC taken along line B-B′ of FIG. 1;

FIG. 4 is an exploded view for a portion of FIG. 2;

FIGS. 5A and 5B are scanning electron microscopic pictures illustrating a surface of a dielectric layer and a cross-section of a MLCC according to an exemplary embodiment of the present invention; and

FIGS. 6A and 6B are scanning electron microscopic pictures illustrating a surface of a dielectric layer and a cross-section of an MLCC according to a comparative example.

### DETAILED DESCRIPTION OF THE PREFERRED EMBODIMENT

Hereinafter, exemplary embodiments of the present invention will be described in detail with reference to the accompanying drawings. However, the exemplary embodiments of the present invention may be modified in various forms and the scope of the present invention is not limited to the exemplary embodiments described below. Exemplary embodiments of the present invention are provided so that those skilled in the art may more completely understand the present invention. Accordingly, shapes and sizes of elements in the drawings may be exaggerated for clear description and like reference numerals refer to like elements throughout the drawings.

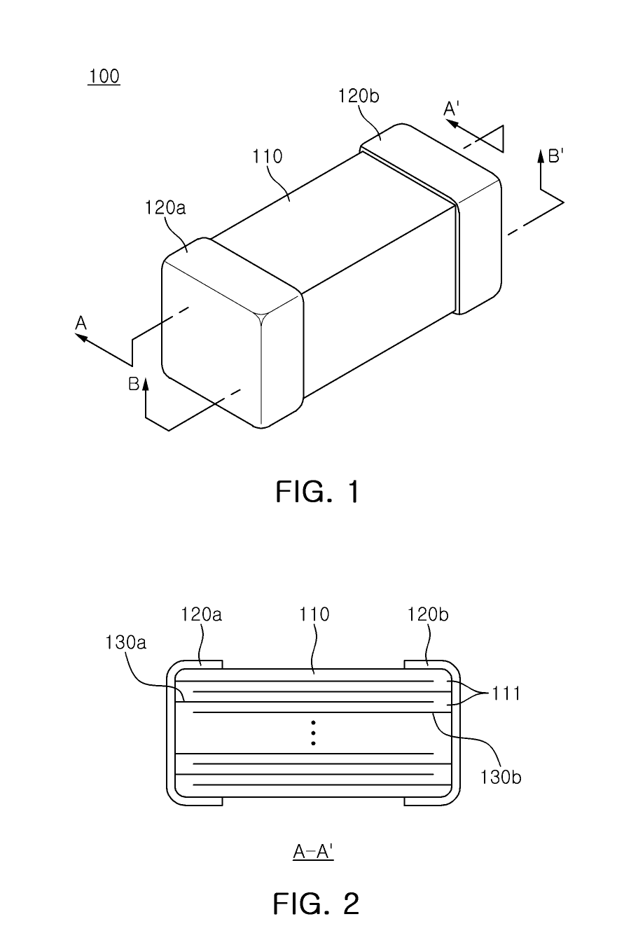

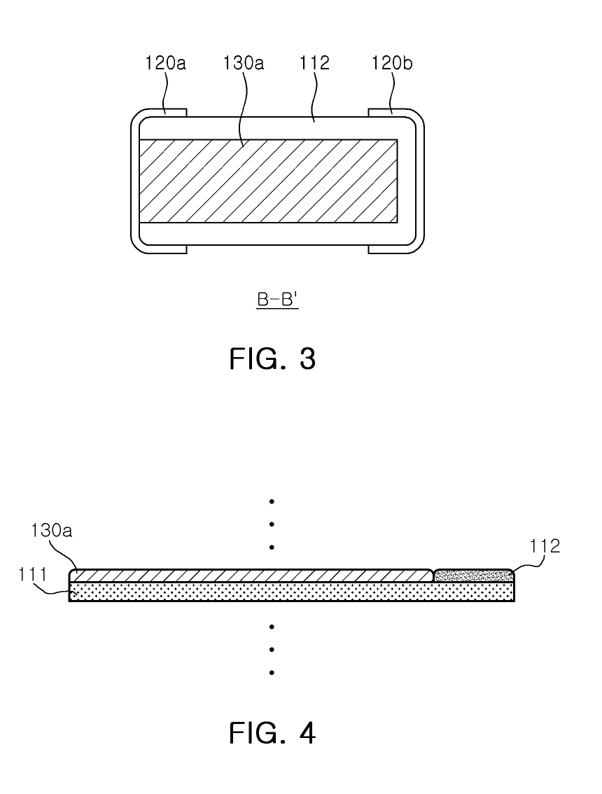

FIG. 1 is a schematic perspective view illustrating an MLCC 100 according to an exemplary embodiment of the present invention, FIG. 2 is a schematic cross-sectional view illustrating an MLCC 100 taken along line A-A′ of FIG. 1, FIG. 3 is a schematic cross-sectional view illustrating an MLCC 100 taken along line B-B′ of FIG. 1, and FIG. 4 is an exploded view for a portion of FIG. 2.

Referring to FIGS. 1 and 4, the MLCC 100 according to an exemplary embodiment of the present invention includes a ceramic element 110 in which a plurality of dielectric layers are stacked, first and second inner electrodes 130a and 130b formed on the single dielectric layer within the capacitor portion, and first and second outer electrodes 120a and 120b are formed on the outer surface of the ceramic element 110.

The shape of the ceramic element 110 is not particularly limited, but may, in general, be rectangular. In addition, the size thereof is not particularly limited, but for example, may be 0.6 mm×0.3 mm and may be a highly-layered and highly-capacitive MLCC of 1.0 μF or more.

The ceramic element 110 may be constituted by a single dielectric layer 111 of a capacitor portion contributing to the formation of capacitance within the capacitor and by a cover dielectric layer formed with a predetermined thickness, the single dielectric layer 111 being alternately stacked with the inner electrode.

The thickness of a single dielectric layer 111 within the capacitor portion may be arbitrarily changed depending on the capacitive design of the MLCC and in the exemplary embodiment of the present invention, thickness of one dielectric layer after firing may be 1.0 μm or less.

The first and the second inner electrodes 130a and 130b maybe opposed to each other with a single dielectric layer 111 of the capacitor portion interposed therebetween. Ends of the respective first and second inner electrodes 130a and 130b may be alternately exposed to the surfaces of respective ends of the ceramic element 110.

The thicknesses of the first and second inner electrodes 130a and 130b may be properly determined as, for example, 1.0 μm or less, according to purpose and designer preference. In addition, the thickness thereof may be selected from within the range of 0.1 to 1.0 μm.

The first and second outer electrodes 120a and 120b are formed on the outer surfaces of both ends of the ceramic element 110 and electrically connected to the alternately exposed ends of the first and second inner electrodes 130a and 130b.

The conductive material used for the first and second outer electrodes 120a and 120b is not particularly limited, but may be one of Ni, Cu, or an alloy thereof. The thicknesses of the first and second outer electrodes 120a and 120b may be properly determined according to the use and the like and for example, may be about 10 to 50 μm.

The dielectric layers constituting the ceramic element 110 may include the ceramic powder which is generally used in the art, but the ceramic powder is not limited thereto and may be a, for example, BaTiO₃-based ceramic powder. Further, the BaTiO₃-based ceramic powder is not limited thereto and for example, may be (Ba₁₋ₓCaₓ) TiO₃, Ba (Ti_{1-y}Ca_{y})O₃, (Ba₁₋ₓCaₓ) (Ti_{1-y}Zr_{y})O₃, or Ba (Ti_{1-y}Zr_{y})O₃ which Ca, Zr, or the is contained in the BaTiO₃. The average particle-diameter of the ceramic powder is not particularly limited and for example, may be 0.8 μm or less, preferably 0.05 to 0.5 μm.

Further, the dielectric layers may include transition metal oxide or carbide, rare earth element, Mg, Al, and the like together with the ceramic powder.

According to the embodiment, the dielectric layer margin portion 112 may be formed in the single dielectric layer 111.

Referring to FIGS. 3 and 4, the first inner electrode 130a is formed on the single dielectric layer 111 and the dielectric layer margin portion 112 is formed at the margin portion of the single dielectric layer 111 in which the first inner electrode 130a is not formed. In the present invention, the region of the dielectric layer which the first inner electrode is not formed is called the margin portion and the dielectric layer formed in the region is called the dielectric layer margin portion.

FIGS. 3 and 4 show only the single dielectric layer 111 with the first inner electrode 130a, but the dielectric layer margin portion may be formed at the margin portion of the single dielectric layer with the second inner electrode.

The dielectric layer margin portion 112 may absorb the step generated by the inner electrode and prevent the diffusion of the inner electrode. The dielectric layer margin portion 112 may be formed of the ceramic paste composition for the ceramic electronic component according to the exemplary embodiment of the present invention.

Hereinafter, a ceramic paste composition for a ceramic electronic component and a method of manufacturing the same according to an exemplary embodiment of the present invention will be described.

As described above, the ceramic paste composition for the ceramic electronic component according to the exemplary embodiment of the present invention may be used for absorbing the step generated by the inner electrode and preventing the diffusion of the inner electrode in the MLCC. In detail, in one dielectric layer, the ceramic paste composition may be used to form the dielectric layer margin-portion at the margin portion of the dielectric layer on which the inner electrode is not formed.

The method of manufacturing the ceramic paste composition for the MLCC will be primarily described. Therefore, components of the ceramic paste composition will be described.

First, an initial mixture of a slurry state comprising a preliminary solvent, a first dispersant, and a ceramic powder is formed. The initial mixture in the slurry state may have a viscosity of 10 to 300 cps, preferably, 50 to 100 cps.

The preliminary solvent is prepared for fabricating the initial mixture in the slurry state and may have relatively low viscosity. It is not limited, but for example, the preliminary solvent may be one of toluene, ethanol, and a mixture thereof. The content of the preliminary solvent may be properly selected depending on the viscosity of the slurry and the content and characteristics of other ingredients, and for example, may be 100 to 500 parts by weight with respect to 100 parts by weight of the ceramic powder.

The first dispersant may be phosphate ester-based dispersant. The phosphate ester-based dispersant improves the dispersibility of the ceramic powder having a relatively small average particle-diameter by bonding on the surface of the ceramic powder. In addition, the first dispersant may prevent the viscosity of the initial mixture in the slurry state from being deteriorated.

The phosphate ester-based dispersant is not particularly limited theretobut for example, may be trimethyl phosphate, triethyl phosphate, tributyl phosphate, trioctyl phosphate, triphenyl phosphate, tricresyl phosphate, trixylenyl phosphate, cresylphenyl phosphate, octyldiphenyl phosphate, or the like, and may be a single or mixture of two or more thereof.

The content of the phosphate ester-based dispersant may be 10 to 30 parts by weight with respect to 100 parts by weight of the ceramic powder.

The kind of the ceramic powder is not specially limited and may be the same as or one similar to the ceramic powder used in the single dielectric layer 111 which is within the capacitor portion.

The average particle-diameter of the ceramic powder may be 100 nm or less. Since the initial mixture in the slurry state has relatively low viscosity, the ceramic powder having a relatively smaller particle-diameter may be uniformly dispersed. The average particle-diameter of the ceramic powder may be 100 nm or less or may be 50 to 80 nm.

The ceramic powder may have excellent dispersibility by disintegrating the initial mixture in the low-viscosity of slurry state.

The disintegrating of the initial mixture may be performed by applying strong impact and stress using a beads mill or a high-pressure sprayer. The disintegrating condition is not limited thereto, but for example, may be a shaft speed of 5 to 10 m/s, flow rate of 30 to 80 hg/hr (by High shear micro Mill), and a solid particle of about 20 to 50 wt/%. The dispersibility of the ceramic powder after disintegrating may be verified by measuring a particle-size of the ceramic powder, a specific surface area (BET), a minute shape using a scanning electron microscope (SEM).

Next, a secondary mixture in a paste state is formed by adding a solvent, a second dispersant, and a binder in the initial mixture. The secondary mixture in the paste state has a high-viscosity characteristic suitable for printing. The viscosity of the secondary mixture may be 5000 to 20000 cps. The viscosity of the secondary mixture may be adjusted in the optimal range according to printing methods and in the case of a screen printing process, may be 7000 to 10000 cps.

In a high viscosity of paste state of the secondary mixture, the dispersing process may be performed by a 3-roll mill method and the like.

The solvent has a higher boiling point and a higher viscosity than the preliminary solvent used in the initial mixture and in general, may be used to fabricate the paste. The particular kinds of the solvent are not limited, but for example, may use a terpineol-based solvent. In more detail, the solvent may be dihydroterpinyl acetate(DHTA).

The terpineol-based solvent is advantageous to fabricate the paste due to high viscosity and to a leveling characteristic after printing because a dry speed is slow due to a high boiling point.

The second dispersant used in the secondary mixture may be a salt bonded material of fatty acid and alkyl amine.

The second dispersant may be represented by following chemical formula.

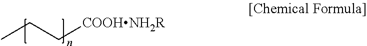

Herein, n is an integer of 3 to 20 and R is alkyl of carbon number of 1 to 10.

The second dispersant may be a salt bonded material of carboxyl group of fatty acid and amine group of alkyl amine.

The second dispersant may improve the dispersibility of the ceramic powder in a high viscosity of paste state.

The content of the second dispersant may be 10 to 30 parts by weight with respect to 100 parts by weight of the ceramic powder.

The binder used in the secondary mixture may be polyvinyl butyral resin and ethyl cellulose resin. The binder is coated on the surface of the ceramic powder in the dispersing process of the secondary mixture. Accordingly, the cohesion of the ceramic powder may be minimized and the dispersing stability may be maintained.

Further, the binder acts to grant the viscosity and thixotrophy of the optimal range such that the secondary mixture is applied to a printing method such as a screen printing and a gravure printing or the like. In addition, the binder acts to implement an adhesive property, phase stability, or a physical property capable of a 3-roll mill.

The polyvinyl butyral resin has excellent bond strength with the ceramic powder. The ethyl cellulose resin has an excellent restoring force of the structure such that the dispersing stability of the ceramic paste may be increased and the bond strength cab be adjusted by adding the ethyl cellulose resin.

The content of the binder may be set by considering the dispersibility, laminating effect, de-binder of the ceramic powder. The content of the binder may be set in the similar range to the content of the binder contained in the ceramic paste which is formed as the single dielectric layer within the capacitor portion. However, the content of the binder is not limited thereto and may be 10 to 30 parts by weight with respect to 100 parts by weight of the ceramic powder. When the content of the binder is less than 10 parts by weight, the dispersibility of the ceramic paste may be deteriorated or the printing characteristic may be deteriorated. In addition, when the content of the binder is more than 30 parts by weight, the de-binder is difficult and the characteristic of the ceramic capacitor may be deteriorated.

Further, a plasticizer may be additionally added to the secondary mixture. The plasticizer may be triethylene glycol-based plasticizer.

The content of the plasticizer is not limited but may be 5 to 20 parts by weight with respect to 100 parts by weight of the ceramic powder.

Further, a removing process of the preliminary solvent may be performed before forming the secondary mixture. The preliminary solvent may be removed by being volatilized by a distiller due to a low boiling point. When the preliminary solvent is removed, the initial mixture in the slurry state may be in a wet cake state. The secondary mixture may be formed in a paste state by adding the solvent used for the secondary mixture with the initial mixture in the wet cake state.

The preliminary solvent may be fully removed, while a part thereof may be not removed and may be remained in the secondary mixture.

Since the single dielectric layer within the capacitor portion may be damaged when the preliminary solvent is remained, the removal of the preliminary solvent may be performed in relatively high ratio.

The preliminary solvent may be difficult to be removed by adding the second dispersant, the binder, or the solvent. Accordingly, in order to increase the removal ratio of the preliminary solvent, the removing process of the preliminary solvent may be performed before adding the solvent, the second dispersant and the binder.

The ceramic paste composition manufactured by the method described above may include the ceramic powder, the first phosphate ester-based dispersant, the second dispersant salt-bonded by the fatty acid and the alkyl amine, the binder including the polyvinyl butyral and ethyl cellulose, and the solvent. In addition, the preliminary solvent having a lower viscosity than the solvent maybe included in the ceramic paste composition in some cases.

In general, the inner electrode or the ceramic powder having a relatively large average particle-diameter can be dispersed by using the 3-roll mill at a high viscosity.

However, since the ceramic powder having the small average particle-diameter has a large specific surface area and a large hardness, the dispersibility is difficult to be ensured at a high viscosity. Furthermore, in order to apply to the ultra-small and ultra-thin MLCC of a 0603 size, the ceramic powder having a relatively smaller particle-diameter should be used, but this case is more difficult to ensure the dispersibility. If the dispersibility of the ceramic powder is not sufficiently ensured, pores are remained in the dielectric layer after sintering such that the capacity and reliability may be deteriorated.

According to the exemplary embodiment of the present invention, the preliminary solvent having a low viscosity is used so as to be suitable for the ceramic powder having a minute particle size, and the cohesion of the ceramic powder is substantially reduced by the disintegrating and dispersing thereof, such that the dispersibility can be ensured. Thereafter, high viscosity is imparted to the paste for printing by using the solvent having a high viscosity. Accordingly, the ceramic powder having a minute particle size may be used.

Further, since the ceramic paste having excellent dispersibility is manufactured as compared with the related art, the surface roughness of the dielectric layer margin-portion using the ceramic paste may be decreased and the dry-film density may be improved.

Hereinafter, a method of fabricating an MLCC according to an exemplary embodiment of the present invention will be described.

First, a plurality of ceramic green sheets are prepared.

In the ceramic green sheet, slurry is manufactured by mixing a ceramic powder, a binder, and a solvent and the slurry may be manufactured in a sheet shape having a thickness of several μm by a doctor blade method. The slurry is slurry for a ceramic green sheet to form a ceramic element comprising a single dielectric layer and a cover-portion dielectric layer.

Next, a conductive paste for an inner electrode is applied on the ceramic green sheet and thus, first and second inner electrode patterns are formed. The first and second inner electrode patterns may be formed by a screen printing method or a gravure printing method.

Thereafter, a dielectric layer margin portion is formed in the margin portion of the ceramic green sheet in which the first and second inner electrode patterns are not formed.

When the ceramic paste for the MLCC according to the exemplary embodiment of the present invention described above is printed on the margin portion of the ceramic green sheet in which the first and second inner electrode patterns are not formed and then, when being fired, the dielectric layer margin-portion 112 maybe formed as shown in FIGS. 3 and 4. The ceramic paste for the MLCC maybe manufactured by the described method. The ceramic green sheet maybe formed as the dielectric layer 111 by the firing as shown in FIGS. 3 and 4.

Thereafter, the plurality of ceramic green sheets are stacked and pressurized from the stacked direction and then the stacked ceramic green sheets and the inner electrode paste are compressed. Accordingly, a ceramic multilayer body in which the ceramic green sheet and the inner electrode paste are alternately stacked, is fabricated. At the time, the inner electrode may stretch or protrude outside of the ceramic green sheet. However, according to the embodiment, the diffusion of the inner electrode pattern is prevented by the ceramic paste (the dielectric layer margin-portion) printed on the margin portion of the ceramic green sheet in which the first and the second inner electrode patterns are not formed. In addition, the generation rate of the step due to the inner electrode is decreased in the multilayer body.

Next, the ceramic multilayer body is chipped by cutting each region corresponding to a single capacitor. At the time, the ceramic multilayer body is cut so that ends of the first and second inner electrode patterns are alternately exposed to respective ends thereof.

Thereafter, the ceramic element is fabricated by firing the chipped multilayer body, for example, at a temperature of about 1200° C.

Next, the first and the second outer electrodes are formed so as to enclose respective ends of the ceramic element and be electrically connected with the first and the second inner electrodes exposed to the respective ends of the ceramic element. Then, the surface of the outer electrode may be plated with a metal such as nickel, tin, or the like.

According to the exemplary embodiment of the present invention, the ceramic paste is manufactured. More particularly, the initial mixture in the slurry state is manufactured and disintegrated by adding BaTiO₃ powder of 100 parts by weight having an average particle-diameter of 100 nm or less and phosphate ester of 10 parts by weight into ethanol. Thereafter, the ethanol is volatilized by the distiller and the dispersant of 10 parts by weight salt-bonded by a fatty acid and an alkyl amine, polyvinyl butyral and ethyl cellulose of 20 parts by weight, and dihydro terpineol solvent of 300 parts by weight are added with the initial mixture in the wet cake state. The dielectric layer is formed by using the secondary mixture in the paste state and the surface roughness and the dry-film density are measured and illustrated in the following Table 1.

In comparative example, the paste is manufactured by adding BaTiO₃ powder of 100 parts by weight having an average particle-diameter of 200 nm or less, nonionic phosphate-based dispersant of 10 parts by weight, and polyvinyl butyral of 10 parts by weight into dihydro terpineol solvent of 300 parts by weight. The dielectric layer is formed by using the paste and the surface roughness and the dry-film density are measured and illustrated in the following Table 1.

TABLE 1

| | Inventive example | Comparative example |
|---|---|---|
| Surface roughness | 0.011 μm | 0.038 μm |
| (Ra) | | |
| Dry-film density | 3.48 | 2.70 |
| (g/cm³) | | |

Referring to Table 1, in the inventive example, the surface roughness (Ra) of the dielectric layer is reduced to ⅓ as being compared with the comparative example. In addition, the dry-film density is increased in comparison with the comparative example. That is, according to the exemplary embodiment of the present invention, the dispersibility of the ceramic powder is improved, such that the cohesion of the particle is decreased and the inner pores are decreased.

Further, characteristics of the MLCC (0603 size) in which the dielectric layer margin-portion is formed by using the ceramic paste according to the inventive example and the comparative example are evaluated and shown in Table 2.

The capacity and dielectric loss (DF) are measured at 1 kHz and 1 Vrms by using a capacitance meter (Agilent, 4284A).

The insulating resistance (IR) is measured by using a high resistance meter (Agilent, 4339B) and the break down voltage (BDV) is measured by using a HV BDV tester (PR12PF).

The short is measured by counting chips in which the capacity value is not measured due to the electric short circuit.

In addition, the crack or not is measured by molding the 100 chips and observing the cross-section through an optical microscope, and the accelerated life is calculated by measuring the insulating resistance value while applying three times rated voltage (6.3V) at a temperature of 150□ for 72 hours.

TABLE 2

| | Inventive example | comparative example |
|---|---|---|
| Porosity of | 0.3 | 3.85 |
| dielectric layer | | |
| margin portion (%) | | |
| Capacity (μF) | 2.268 | 1.982 |
| DF (%) | 0.043 | 0.046 |
| IR (MΩ) | 29.2 | 15.5 |
| BDV (V) | 28 | 19 |
| Short (%) | 3 | 94 |

Referring to Table 2, in the inventive example, the dispersibility is increased, such that the porosity in firing is remarkably reduced. Accordingly, the capacity is increased by about 15%. In addition, the crack is not generated and the break down voltage (BDV), the capacity value, and the accelerated life are improved as compared with the comparative example. In addition, the increase of the dispersibility can be verified by the decrease of the short rate, and the short rate is relatively largely improved as compared with the comparative example.

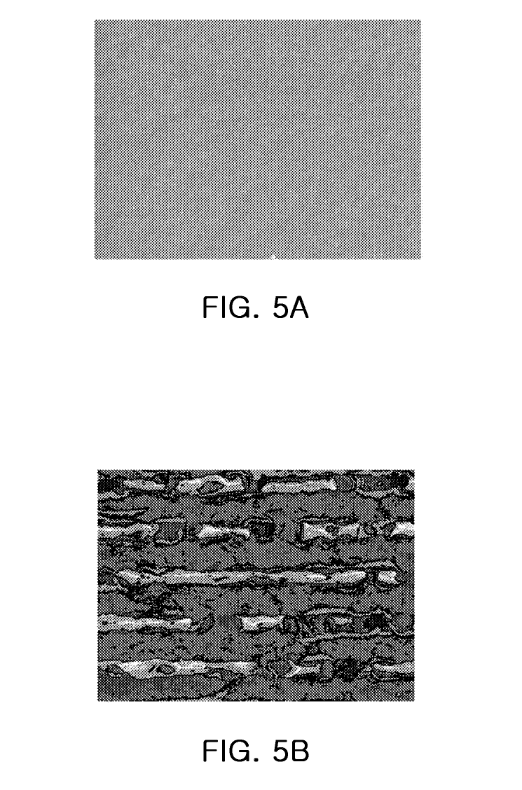

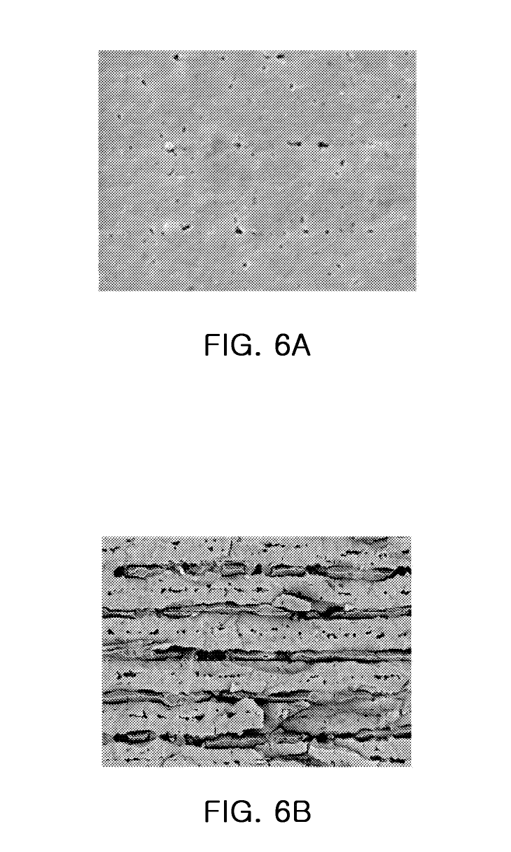

FIGS. 5 and 6 are scanning electron microscopic pictures illustrating surfaces of a dielectric layer and cross-sections of an MLCC according to the inventive example and the comparative example.

More in detail, FIG. 5A is a scanning electron microscope (SEM) picture illustrating a fine structure of a dielectric layer to which a ceramic paste according to the inventive example is applied, and FIG. 5B is a cross-sectional picture in an L direction of an MLCC.

FIG. 6A is a scanning electron microscope (SEM) picture illustrating a fine structure of a dielectric layer applying a ceramic paste according to the comparative example, and FIG. 6B is a cross-sectional picture in an L direction of an MLCC.

Referring to FIGS. 5 and 6, in the comparative example, since the dispersibility of the ceramic paste is deteriorated, the inner pores after firing is increased, but in the inventive example, since the dispersibility of the ceramic paste is improved, the pores is decreased.

Since the dielectric layer is printed on the margin portion by the ceramic paste fabricated according to the exemplary embodiment of the present invention, the stretchiness of the electrode is prevented in the stacking and compressing processes, such that the cutting yield may be increased. Further, the porosity of the dielectric layer margin-portion is decreased by the increase of the dispersibility of the dielectric paste and the capacity is increased and the short rate is decreased by the relative increase of the thickness of the electrode.

As set forth above, according to an embodiment of the present invention, a ceramic paste composition is manufactured by substituting a solvent appropriate for printing after the solvent is applied to be suitable for the dispersing condition of a ceramic powder.

Accordingly, the ceramic powder having a relatively small average particle-diameter may be used and the dispersibility of the ceramic powder is excellent in the paste.

A dielectric layer formed of the ceramic paste which is manufactured by the method as described above has the excellent surface roughness and dry-film density, and the relatively low porosity.

When a dielectric layer margin portion is formed at the MLCC by using the ceramic paste according to the exemplary embodiment of the present invention, the sinterability is improved and the deformation of an inner electrode can be prevented. Further, the dielectric layer margin portion has the uniform surface roughness and the excellent density. Accordingly, the capacity of the MLCC is increased and the insulation resistance and the insulation breakdown voltage value are improved. Further, the short rate is improved, such that the stabilized electric characteristic is implemented and the yield can be increased.

Therefore, it is possible to contribute to the development of models of an ultra-small and ultra-thin MLCC.

In addition, as set forth above, the present invention provides an ultra-capacity ceramic electronic component capable of forming a thin inner electrode layer due to excellent dispersibility.

While the present invention has been shown and described in connection with the exemplary embodiments, it will be apparent to those skilled in the art that modifications and variations can be made without departing from the spirit and scope of the invention as defined by the appended claims. Accordingly, the scope of the present invention will be determined by the appended claims.

What is claimed is:

1. A ceramic paste composition for a multilayer ceramic capacitor, comprising:
a ceramic powder;
a first phosphate ester-based dispersant and a second dispersant salt-bonded by a fatty acid and an alkyl amine;
a binder including polyvinyl butyral and ethyl cellulose; and
a solvent.

2. The ceramic paste composition of claim 1, further comprising a preliminary solvent having a lower viscosity than the solvent.

3. The ceramic paste composition of claim 1, wherein the ceramic powder has an average particle-diameter of 100 nm or less.

4. The ceramic paste composition of claim 1, wherein the solvent is a terpineol-based solvent.

5. The ceramic paste composition of claim 2, wherein the preliminary solvent is one or more selected from a group composed of toluene, ethanol, and a mixture thereof.

6. The ceramic paste composition of claim 1, wherein the content of the first dispersant is 10 to 30 parts by weight with respect to the ceramic powder of 100 parts by weight.

7. The ceramic paste composition of claim 1, wherein the content of the second dispersant is 10 to 30 parts by weight with respect to the ceramic powder of 100 parts by weight.

8. The ceramic paste composition of claim 1, wherein the content of the binder is 10 to 30 parts by weight with respect to the ceramic powder of 100 parts by weight.

9. The ceramic paste composition of claim 1, wherein the viscosity of the ceramic paste is 5000 to 20000 cps.

10. A method of manufacturing a ceramic paste for a multilayer ceramic capacitor, comprising:
manufacturing an initial mixture in a slurry state comprising a ceramic powder, a preliminary solvent, and a first phosphate ester-based dispersant; and
manufacturing a secondary mixture in a paste state by mixing a second dispersant salt-bonded by a fatty acid and an alkyl amine, a binder including polyvinyl butyral and ethyl cellulose, and a solvent having a higher boiling point and a higher viscosity than that of the preliminary solvent with the initial mixture.

11. The method of claim 10, further comprising removing the preliminary solvent before forming the secondary mixture.

12. The method of claim 10, wherein the preliminary solvent is one or more selected from a group composed of toluene, ethanol, and a mixture thereof.

13. The method of claim 10, wherein the solvent is a terpineol-based solvent.

14. The method of claim 10, wherein the ceramic powder has an average particle-diameter of 100 nm or less.

15. The method of claim 10, wherein the viscosity of the initial mixture in the slurry state is 10 to 300 cps.

16. The method of claim 10, wherein the viscosity of the secondary mixture in the paste state is 5000 to 20000 cps.

17. A multilayer ceramic capacitor, comprising:
a ceramic element comprising a plurality of dielectric layers stacked therein;
a plurality of inner electrodes formed on respective dielectric layers;
a dielectric layer margin portion formed in margin portions of a dielectric layer on which the inner electrode is not formed, and formed of a ceramic paste composition comprising a ceramic powder, a first phosphate ester-based dispersant, a second dispersant salt-bonded by a fatty acid and an alkyl amine, a binder comprising polyvinyl butyral and ethyl cellulose, and a solvent; and
an outer electrode formed on the outer surface of the ceramic element.

18. The multilayer ceramic capacitor of claim 17, wherein the ceramic paste composition further includes a preliminary solvent having a lower viscosity than the solvent.

19. The multilayer ceramic capacitor of claim 17, wherein the ceramic powder included in the ceramic paste composition has an average particle-diameter of 100 nm or less.

20. A method of fabricating a multilayer ceramic capacitor, comprising:
preparing a plurality of ceramic green sheets;
forming an inner electrode pattern on each of the plurality of ceramic green sheets;
forming a dielectric layer margin portion in margin portions of a dielectric layer on which the inner electrode is not formed, by using a ceramic paste comprising a ceramic powder, a first phosphate ester-based dispersant, a second dispersant salt-bonded by a fatty acid and an alkyl amine, a binder including polyvinyl butyral and ethyl cellulose, and a solvent;
forming a ceramic multilayer body by stacking the ceramic green sheets with the inner electrode patterns formed thereon;
forming a ceramic element by firing the ceramic multilayer body; and
forming an outer electrode on the outer surface of the ceramic element.

21. The method of claim 20, wherein the ceramic paste is manufactured comprising:
manufacturing an initial mixture in a slurry state comprising a ceramic powder, a preliminary solvent, and a first phosphate ester-based dispersant; and
manufacturing a secondary mixture in a paste state by mixing a second dispersant salt-bonded by a fatty acid and an alkyl amine, a binder including polyvinyl butyral and ethyl cellulose, and a solvent having a higher boiling point and a higher viscosity than the preliminary solvent with the initial mixture.

22. The method of claim 21, further comprising removing the preliminary solvent before forming the secondary mixture.

23. The method of claim 21, wherein the preliminary solvent is one or more selected from a group composed of toluene, ethanol, or a mixture thereof.

24. The method of claim 21, wherein the solvent is a terpineol-based solvent.

25. The method of claim 21, wherein the ceramic powder has an average particle-diameter of 100 nm or less.

26. The method of claim 21, wherein the viscosity of the initial mixture in the slurry state is 10 to 300 cps.

27. The method of claim 21, wherein the viscosity of the secondary mixture in the paste state is 5000 to 20000 cps.
